(19) United States
(12) Patent Application Publication
(10) Pub. No.: US 2003/0034636 A1
(43) Pub. Date: Feb. 20, 2003

(54) Wheeled foldable carrying apparatus

(76) Inventor: Kin Ng, Los Angeles, CA (US)

Correspondence Address: Michael A. Painter, 8484 Wilshire Boulevard, Suite 850, Beverly Hills, CA, 90211, US

(21) Appl. No.: 09/920,969

(22) Filed: Aug. 2, 2001

(51) Int. Cl. B62B 1/20

(52) U.S. Cl. 280/652; 280/47.24

(57) ABSTRACT

A foldable carrying apparatus is provided that is capable of transporting stored items and is capable of being folded when not in use. A flexible, foldable container acts as a storage member. The foldable member includes a rigid bottom platform and a pair of spaced, flexible side panels affixed thereto. A pair of hinged wheels are secured to the rigid bottom platform of the storage member. In the folded position, the wheels are maintained in parallel, spaced relation to the platform. A pair of telescoping, foldable support shafts are secured to the bottom platform and adapted to be extended in spaced relation to one of the side panels of the storage container. A pair of receiving members are secured to the side panel of the storage container in opposition to the respective telescoping shafts. When the telescoping shafts are in their extended position, each will engage one of the respective receiving members maintaining the storage container in its open position. When the wheels, and telescoping shafts are pivoted adjacent the ridged platform, the storage container may be folded into a compact, closed position.

### BACKGROUND OF THE INVENTION

1. Field of the Invention

The present invention generally relates to luggage or storage articles and in particular relates to wheeled, foldable luggage or storage articles.

2. Description of the Prior Art

The prior art discloses numerous devices which constitute collapsible and wheeled luggage carts. Typically, the carts disclosed by the prior art incorporate a pair of wheels which are secured to a platform adapted for receiving luggage or the like. A telescoping handle is generally secured in a perpendicular relationship to the platform to permit a user to move the cart upon the surface of the wheels.

The prior art also discloses carrying devices which incorporate conventional wheeled carts with a joined container such as a suitcase. The inadequacy of this design is inherent in its construction. The sidewalls of the suitcase are rigid thereby preventing the structure from being stored within a space which is smaller than the suitcase. In addition, the typical weight of the suitcase and cart preclude it from being easily transported by the user.

The present invention substantially resolves those defects exhibited by the devices disclosed by the prior art. A flexible, foldable container acts as the storage member. The storage member includes a rigid bottom surface and a pair of parallel, spaced side walls affixed to edges of the rigid panel. A pair of hinged wheels are affixed to the bottom surface of the rigid panel in opposition to the storage member. In their open position, the wheels rotate about a common axis. In their folded position, the wheels lie in a common plane adjacent the bottom surface of the rigid panel.

To provide the flexible storage member with rigidity when in use, a pair of pivoting, telescoping shafts are secured to the rigid panel adjacent one of the flexible panels side of the storage member. Receiving members are secured to the side of the storage member in opposition to the telescoping shafts. When the telescoping shafts are extended and engaged with the receiving members, the storage member will be maintained in an open position. When the wheels and telescoping members are pivoted adjacent the surfaces of the rigid panel, the entire structure may be folded about itself into a volume that approximates the thickness of the storage member alone.

### SUMMARY OF THE INVENTION

The primary objective of the present invention is to provide a wheeled, foldable storage carrier which employs a flexible container which may be maintained in a rigid position during use and which may be foldable for storage when not in use. Contrary to the rigid devices (e.g. suitcases) disclosed by the prior art, the present invention employs a flexible container as a storage member. The storage member comprises flexible side and bottom surfaces manufactured of cloth or the like. The side and bottom surfaces of the storage member define a cavity within which articles may be disposed. A rigid panel is affixed to the bottom surface. A pair of pivotable wheels are secured to the bottom surface of the rigid panel in opposition to the side panels of the storage container. When folded, the wheels will lie in a plane which is parallel to and substantially adjacent the rigid panel.

In order to maintain the flexible storage container in an open position for use, a pair of telescoping shafts are pivotally coupled to the rigid bottom panel of the storage container. The telescoping shafts may be pivoted to a position substantially adjacent the surface of the rigid panels or be rotated to a position in parallel spaced relation to a side panel of the storage member. A pair of receiving members are secured to a side panel of the storage container in opposition to the telescoping shafts, each being adapted to receive a telescoping shaft. When engaged, the telescoping shafts will maintain the flexible storage member in an open position. When the wheels and telescoping shafts are pivoted adjacent the rigid panel, the entire structure of the present invention may be folded into a volume which approximates the total size of the rigid panel and affixed wheels.

It is therefore an object of the present invention to provide a foldable, flexible storage carrier which may be maintained in a rigid, open position.

It is another object of the present invention to provide a wheeled storage carrier which may be folded into a small volume when not in use.

It is still another object of the present invention to provide a wheeled, foldable storage carrier that is simple and inexpensive to fabricate.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWING

FIG. 1 is a perspective view of a wheeled, foldable carrying apparatus in accordance with the present invention.

FIG. 2 is a partial, rear elevation view of the present invention shown in FIG. 1 illustrating the alternative position of the pivotable wheels and telescoping shafts.

FIG. 3 is a partial, bottom view of the present invention illustrating the alternative position of the wheels.

FIG. 4 is an enlarged, schematic view of the wheel coupling shown in FIG. 2 and FIG. 3.

FIG. 5 is a side elevation view of the wheel coupling shaft shown in FIG. 4.

FIGS. 6(a) and 6(b) illustrate sequential side elevation views of the present invention while being folded into a storage position.

### DESCRIPTION OF THE PRESENTLY PREFERRED EMBODIMENT

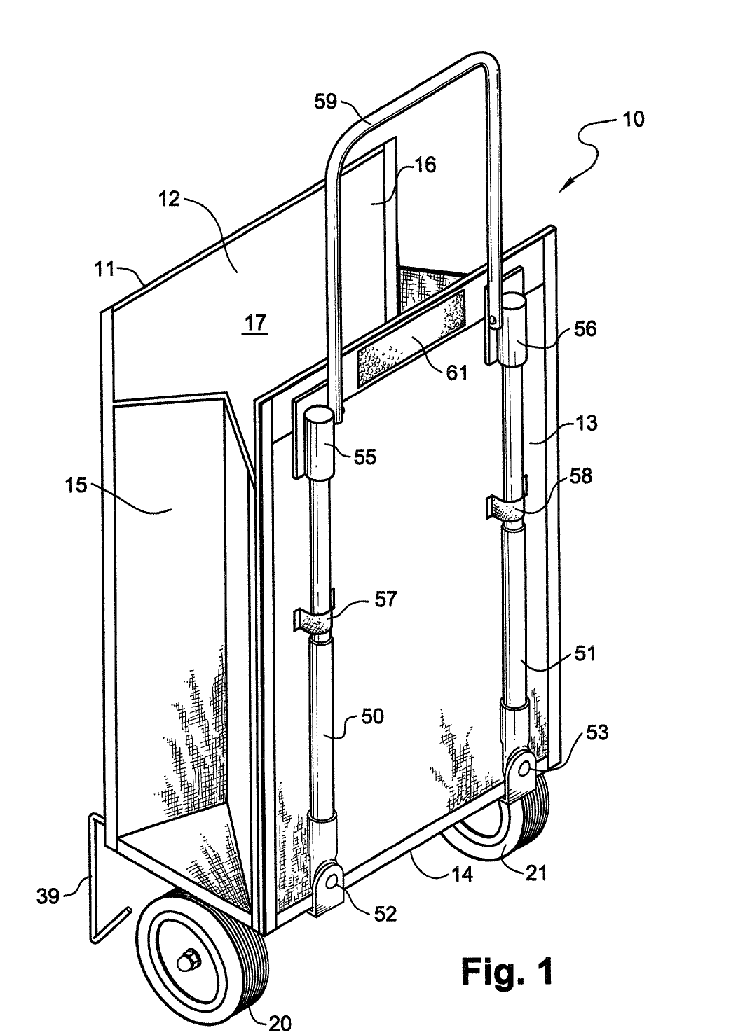

An understanding of the present invention foldable carrying apparatus may be best gained by reference to FIGS. 1, 2 and 3 wherein the present invention is generally designated by the reference numeral 10. The present invention carrying apparatus 10 is intended to provide means for carrying or otherwise transport miscellaneous objects. This objective is accomplished through the use of flexible storage member 11. Flexible storage member 11 comprises a pair of opposed side walls 12 and 13, a rigid base panel 14 and a pair of expansion panels 15 and 16 which are secured to side walls 12 and 13 and base panel 14 to create an interior cavity 17 within which merchandise or other articles may be inserted. Storage member 11 is constructed of a flexible, pliant material such as cloth which enables implementation of a primary objective of the present invention to permit the carrying apparatus to be folded and stored when not in use.

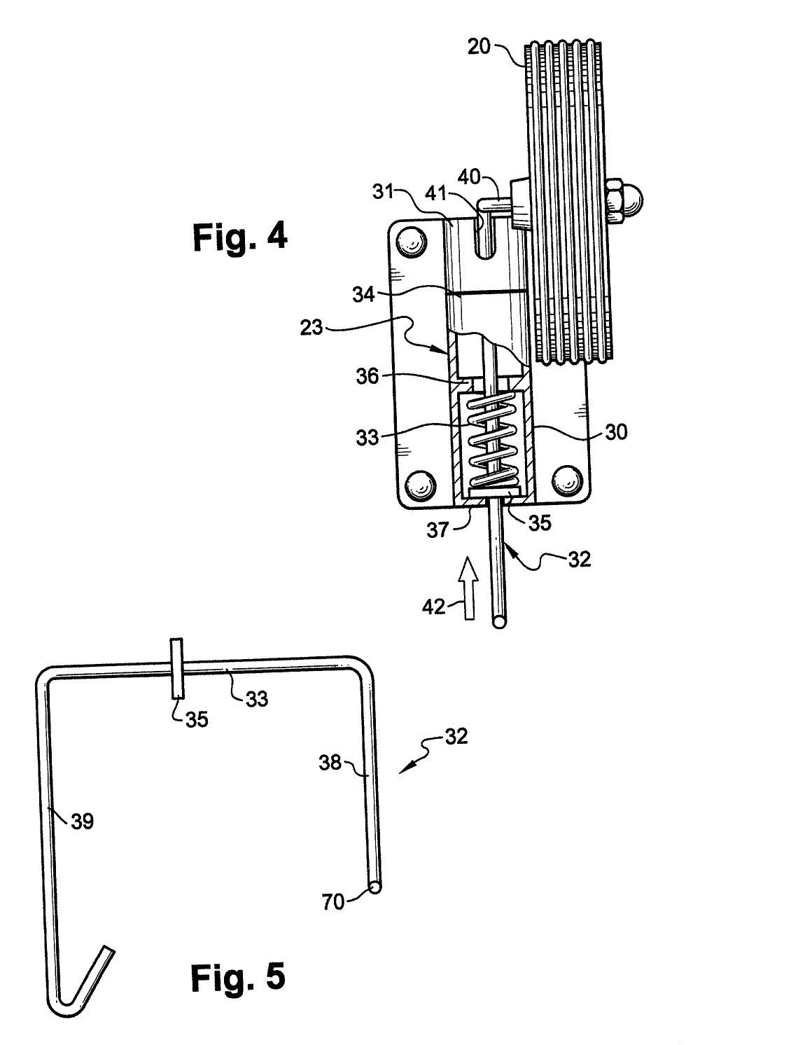

An objective of the present invention is to provide a wheel storage carrier which can be folded into a small volume. Although side walls 12 and 13 and expansion panels 15 and 16 are flexible, base panel 14 is structurally rigid. A pair of wheels 20 and 21 are pivotally coupled to the bottom surface 22 of base panel 14. Wheels 20 and 21 are pivotally coupled to base panel 14 pursuant to a pivotal coupling 23 shown in FIGS. 4 and 5.

Each of the pivotal couplings 23 comprise a housing 30 which is secured to bottom surface 22 of base panel 14. Housing 30 is semi-cylindrical and defines a uniform channel 31 therethrough. Wheel mounting shaft 32 includes an elongated section 33 which is adapted to be disposed within channel 13. The wall of channel 31 extends inwardly into a projection 34 surrounding elongated section 331 projection 34 being concentric with elongated section 33. Elongated shaft 33 includes an outwardly directed projection 35. As can be best seen in FIG. 4, a resilient member such as a helical spring 36 is disposed intermediate projections 34 and 35 resiliently urging projection 35 toward wall 37 of housing 30.

Elongated section 33 of wheel mounting shaft 32 depends into a first extension 38 at one end thereof, and into a second extension 39 at the opposed end thereof. First and second extensions 38 and 39 are parallel to each other and are co-planar with elongated section 33. Second extension 39 provides the means to position the present invention carrier apparatus 10 in an upright position when it is being used. First extension 38 depends into wheel mounting flange 40 which is perpendicular to first and second extensions 38 and 39 and elongated shaft 33. As shown in FIGS. 3 and 4, wheels 20 and 21 are axially disposed upon and rotatably mounted upon respective wheel mounting flanges 40.

Wheels 20 and 21 may be pivotally rotated between the open and closed positions. In FIG. 4, wheel mounting shaft 32 has been rotated to place wheel 20 in the open position. The open position exists when first extension 38 is disposed within slot 41 of housing 30. The open position will be maintained as a result of the force imposed by helical spring 36 against projections 34 and 35. To place wheel 20 and 21 in the closed or folded positions, force is exerted against second extension 39 in the direction indicated by reference numeral 42. Once first extension 38 is displaced from slot 41, it may be rotated in the direction shown in FIG. 3 until wheel 21 is placed adjacent surface 22 of rigid base panel 14.

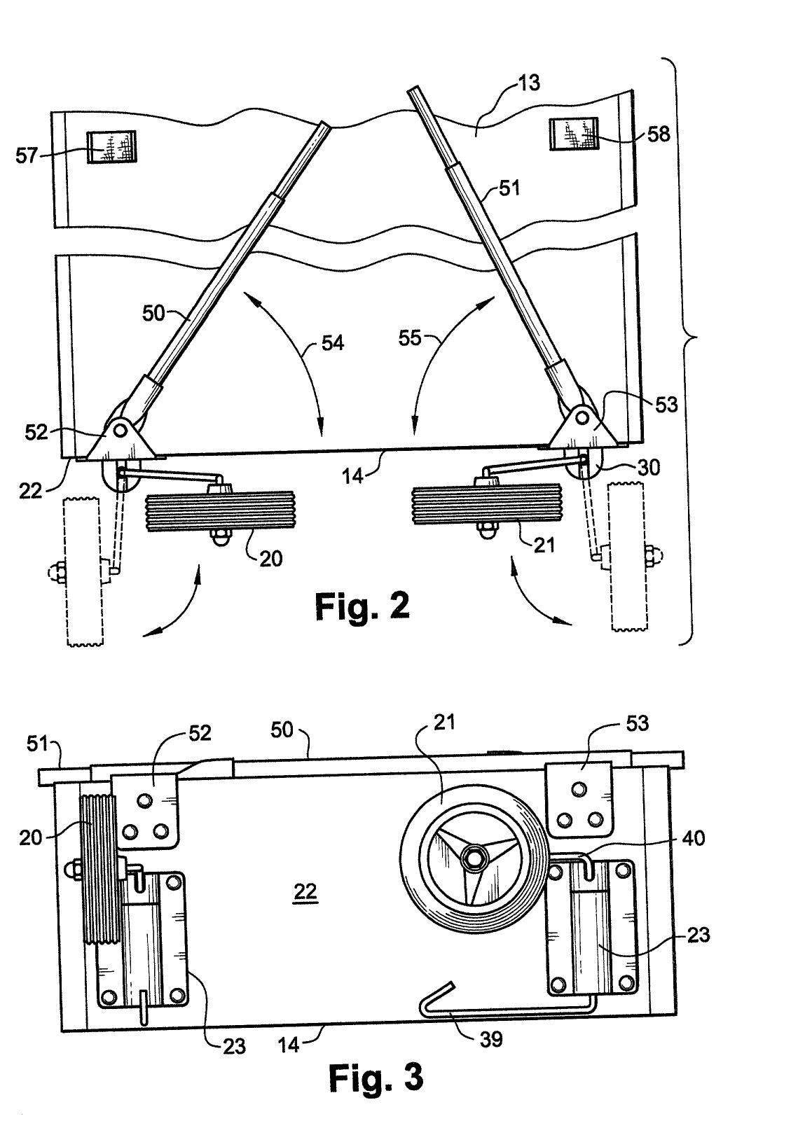

Since storage member 11 is made of flexible material, it is an objective of the present invention to provide means to reinforce the storage member 11 when it is being used. As can be seen in FIG. 1 and FIG. 2, telescoping shafts 50 and 51 are pivotally coupled to base panel 14 by pivoting members 52 and 53 which permit telescoping members 51 to alternatively be rotated in the direction shown by reference numerals 54 and 55, respectively. In the open position, telescoping shafts 50 and 51 may be rotated until they are perpendicular to base panel 14. In the folded position shown in FIG. 3, telescoping shafts 50 and 51 are rotated until substantially co-planar with surface 22 of base panel 14.

The reinforcement of side panel 13 of storage member 11 can be best understood by reference to FIG. 1. Receiving members 55 and 56 are secured to side panel 13 and are adapted to be aligned with telescoping shafts 50 and 51. Receiving members 55 and 56 include an internal aperture adapted to be axially aligned with telescoping shafts 50 and 51 respectively. When telescoping shafts 50 and 51 are extended, they may be engaged within the apertures disposed within receiving members 55 and 56. Once the telescoping shafts are engaged within receiving members 55 and 56, respectively, they will be maintained in the position shown in FIG. 1 and will be maintained in place until disengaged. To further reinforce side panel 13, bracing strips 57 and 58 are secured to side panel 13. Bracing strip 57 is disposed intermediate receiving member 55 and pivoting member 52. In a like manner, bracing strip 58 is disposed intermediate receiving member 56 and pivoting member 53. As shown in FIG. 1, telescoping members 50 and 51 are disposed intermediate side panel 13 and bracing strips 57 and 58, respectively, when they are expanded and extended into the receiving members 55 and 56. A rotatable handle 59 is disposed between receiving members 55 and 56 to provide means for the user to move the present invention carrier when it is being used.

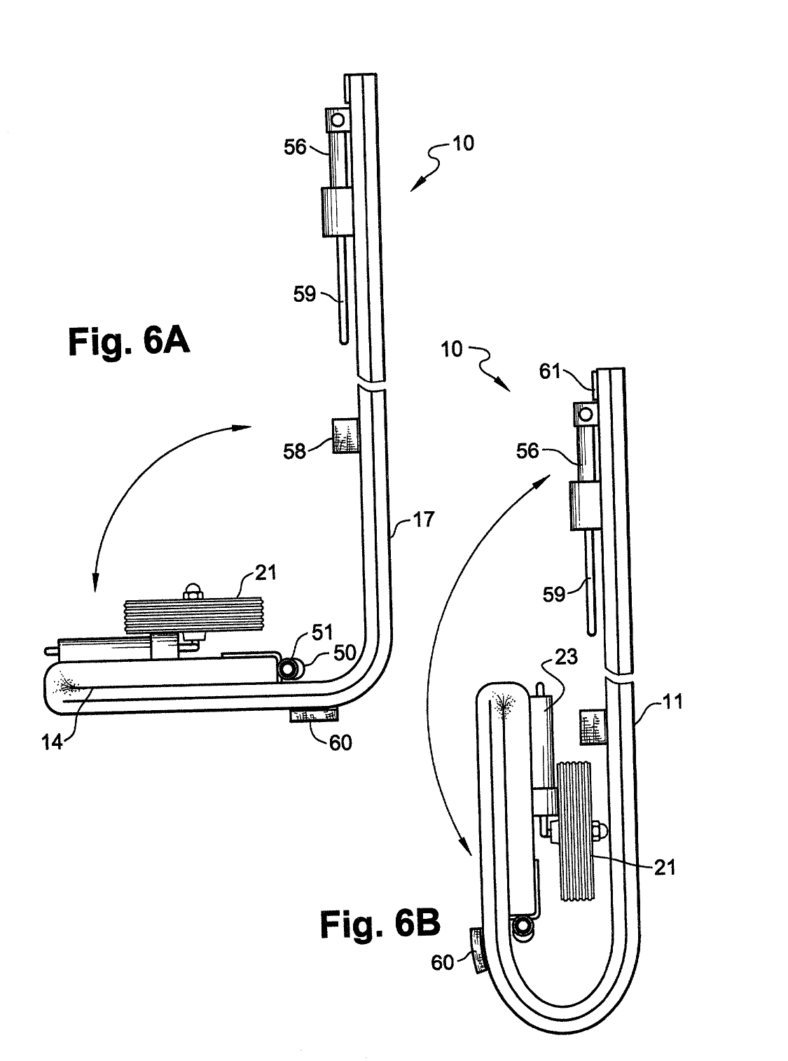

A primary objective of the present invention is to provide a carrying apparatus which can be folded into a small volume when not in use. Referring now to FIGS. 6(a) and 6(b), the present invention carrying apparatus 10 is shown in a sequence of folding maneuvers. Prior to folding the present invention 10 for storage, wheels 20 and 21 are pivoted to the position shown in FIG. 2. The telescoping shafts 50 and 51 are pivoted to the position shown in FIG. 3. As shown in FIG. 6(a), storage member 11 is folded about the edge of base panel 14. To provide for means to maintain the storage member 11 in a closed position, engageable members 60 and 61 are affixed to respective ones of the side walls 12 and 13 respectively. As shown in FIG. 6(b), when fully folded, engagement members 60 and 61 will be in contact maintaining store member 11 in the closed position.

I claim:

1. A foldable storage apparatus comprising:
(a) a storage member having first and second side panels and a rigid base panel having top and bottom surfaces, said side panels being coupled to said base panel to define an opening therein;
(b) first and second wheels pivotally copuled to the bottom surface of said base panels;
(c) first and second extendable telescoping supports pivotally coupled to the base panel, said telescoping supports being adapted to be disposed parallel to each other and perpendicular to said base panel adjacent said first side panel;
(d) means for coupling the telescoping supports to said first side panel when said telescoping supports are extended and secured to said first side panel in opposition to said base panel.

2. A foldable storage apparatus as defined in claim 1 further including first and second bracing strips secured to said first side panel each being adapted to receive a respective one of said first and second extendable telescoping supports.

3. A foldable storage apparatus as defined in claim 1 further including first and second closure means secured to said first and second side panels respectively and adapted to be engaged to one another.
